(19) United States
(12) Patent Application Publication
(10) Pub. No.: US 2005/0104509 A1
(43) Pub. Date: May 19, 2005

(54) Electroluminescent device

(75) Inventor: Seiji Yamashita, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 10/990,370

(22) Filed: Nov. 18, 2004

(30) Foreign Application Priority Data
Nov. 19, 2003 (JP) P.2003-389546

(51) Int. Cl. H01J 1/62

(52) U.S. Cl. 313/503

(57) ABSTRACT

To provide an electroluminescent device capable of emitting light with sufficiently high luminance even when applied to a large-area display of 0.25 m² or more, ensuring good driving efficiency and causing less reduction of luminance due to heat generation, the electroluminescent device contains: a transparent conductive film; a light-emitting layer containing a phosphor particle and a binder; and a back electrode, wherein the transparent conductive film has a surface resistivity of 0.05 to 50 Ω/□, the light-emitting layer has an average thickness of 1 to 25 μm, and the back electrode comprises a metal.

### BACKGROUND OF THE INVENTION

1. Field of the Invention

The present invention relates to an electro-luminescent device (hereinafter sometimes called an “EL device”) and a large-sized high-luminance flat light source system using the same.

2. Background Art

Electroluminescent devices are roughly divided into a particle dispersion-type device comprising a high dielectric material having dispersed therein phosphor particles and a thin film-type device comprising a phosphor thin film interposed between dielectric materials. The present invention relates to a former particle dispersion-type device.

Out of AC-driving electroluminescent materials, the particle dispersion-type device can be relatively easily made to have a large area and for use as a flat-type light source, its development is proceeding. With recent diversification of various electronic devices, the particle dispersion-type device is not only used as a display device but also applied to display materials for decoration.

In the dispersion-type device, a light-emitting layer comprising a high dielectric polymer such as fluororubber or polymer having a cyano group, and containing a phosphor powder in the polymer is provided between a pair of conductive electrode sheets with at least one electrode sheet being light-transmitting. Furthermore, in order to prevent the dielectric breakdown, a dielectric layer comprising a high dielectric polymer and containing a ferroelectric powder such as barium titanate in the polymer is usually provided. The phosphor powder used usually comprises ZnS as a matrix, where a proper amount of ion such as Mn, Cu, Cl, Ce, Au, Ag and Al is doped. The particle size in general is from 20 to 30 μm.

The dispersion-type device is characterized in that a flexible material constitution using a plastic substrate can be established because of no use of a high-temperature process at the fabrication of device, the device can be produced at a low cost through a relatively simple step without using a vacuum unit, and the emission color of the device can be easily controlled by mixing a plurality of phosphor particles differing in the emission color, and by virtue of these characteristics, this device is being applied to backlight and display devices. However, the emission luminance is low and white emission is insufficient. In many cases, pseudo-white light emission is formed by using a fluorescent dye in combination, but the application range is limited. More improvements in emission luminance and emission efficiency are demanded.

In order to elevate the emission luminance of the dispersion-type device, various designs have been heretofore made primarily in the formation of phosphor particle. For example, JP-A-6-306355 discloses that two-stage baking and imposing an impact to the particle between bakings are useful for the elevation of luminance.

JP-A-3-86785 and JP-A-3-86786 describe a technique of performing the baking in an atmosphere of hydrochloric acid and hydrogen sulfide, thereby elevating the luminance.

Also, a method of spraying a gaseous dissolved salt to cause thermal decomposition-reaction and effect particle formation, thereby forming homogeneous phosphor particles is disclosed (see, for example, JP-A-2002-322469, JP-A-2002-322470 and JP-A-2002-322472).

However, in these methods, controlled particle formation through steps of uniform nucleation and subsequent growth is not realized, as a result, a particle showing electroluminescence with high luminance and high efficiency cannot be obtained.

JP-B-7-58636 discloses that when the relationship between the size and distribution of phosphor particle and the thickness of light-emitting layer is maintained at constant conditions, a high-luminance electroluminescent device can be provided. However, the high-luminance emission of the electroluminescent device by this method is still not satisfied. Furthermore, even if high-luminance emission is attained, the luminance half-life is extremely short or when the area is enlarged, high-luminance emission cannot be obtained.

In recent years, display advertisement by a large-sized color photographic print or inkjet print or the like is increasing. The display method includes, for example, a method of allowing for enjoyment of an image formed on a support by irradiating light from the image side (reflection system) and a method of allowing for enjoyment by irradiating light from the back side of the image (transmission system). Under specific conditions such as indoor display or outdoor-night display, the latter transmission system is known to provide a clearer image.

Also, the display advertisement provides a greater advertisement effect as the size is larger and therefore, a large-size photosensitive material or print material for display advertisement is demanded. For the large-size display, a large-size flat light source using a fluorescent tube or a cold cathode tube is necessary, but such a light source is heavy and nonportable, consumes a great electric power and is largely restricted in the installation place or environment on use.

### SUMMARY OF THE INVENTION

The present invention has been made under these circumstances, and an object of the present invention is to provide an electroluminescent device having a large emission area and emitting high-luminance light.

More specifically, an object of the present invention is to provide an electroluminescent device capable of emitting light having sufficiently high luminance even when applied to a large-area display of 0.25 m² or more, and ensuring good driving efficiency and small reduction of luminance due to heat generation.

As a result of intensive investigations, the present inventors have found it important to, in addition to conventional techniques for elevating the efficiency of phosphor particle, integrally achieve, for example, improvement of high-frequency driving characteristics of a large-area device, decrease in the reduction of luminance due to heat generation and enhancement of the effective electric field by thinning the light-emitting layer, and discovered a measure for realizing this. The object of the present invention can be attained by the following matters specifying the present invention and preferred embodiments thereof.

(1) An electroluminescent device comprising:
a transparent conductive film;
a light-emitting layer comprising a phosphor particle and a binder; and
a back electrode,
wherein
the transparent conductive film has a surface resistivity of 0.05 to 50 Ω/□,
the light-emitting layer has an average thickness of 1 to 25 μm, and
the back electrode comprises a metal.

(2) The electroluminescent device as described in (1), wherein the transparent conductive film has a surface resistivity of 0.1 to 30 Ω/□.

(3) The electroluminescent device as described in (1) or (2), wherein the light-emitting layer has an average thickness of 3 to 20 μm.

(4) The electroluminescent device as described in any one of (1) to (3), wherein the metal comprises at least one of gold, silver, platinum, copper, iron and aluminum.

(5) The electroluminescent device as described in any one of (1) to (4), wherein the back electrode has a thermal conductivity of 2.8 W/cm·deg or more.

(6) The electroluminescent device as described in any one of (1) to (5), wherein the phosphor particle has an average equivalent-sphere diameter of 0.15 to 15 μm.

(7) The electroluminescent device as described in any one of (1) to (6), wherein the phosphor particle has an average equivalent-sphere diameter of 1 to 10 μm.

(8) The electroluminescent device as described in any one of (1) to (7), wherein the phosophor layer has a weight ratio of the phosphor particle to the binder of 4.2 to 20.

(9) The electroluminescent device as described in any one of (1) to (8), wherein the light-emitting layer has a weight ratio of the phosphor particle to the binder of 4.5 to 10.

(10) The electroluminescent device as described in any one of (1) to (9), wherein 50% or more of fragments having a thickness 0.15 to 0.2 μm, the fragments being obtained by crushing the phosphor particle having a thickness of more than 0.2 μm, and phosphor particles having a thickness of 0.15 to 0.2 μm are phosphor particles having stacking faults of 10 or more layers at intervals of 5 nm or less.

(11) The electroluminescent device as claimed in any one of (1) to (10), wherein 60% or more of fragments having a thickness 0.15 to 0.2 μm, the fragments being obtained by crushing the phosphor particle having a thickness of more than 0.2 μm, and phosphor particles having a thickness of 0.15 to 0.2 μm are phosphor particles having stacking faults of 10 or more layers at intervals of 5 nm or less.

(12) The electroluminescent device as described in any one of (1) to (11), wherein 70% or more of: fragments having a thickness 0.15 to 0.2 μm, the fragments being obtained by crushing the phosphor particle having a thickness of more than 0.2 μm, and phosphor particles having a thickness of 0.15 to 0.2 m are phosphor particles having stacking faults of 10 or more layers at intervals of 5 nm or less.

(13) The electroluminescent device as described in any one of (1) to (12), which has an emission area of 0.25 m² or more.

(14) The electroluminescent device as described in any one of (1) to (13), wherein the phosphor particle is a semiconductor particle comprising:
at least one element selected from the group consisting of Group II elements and Group VI elements; and
at least one element selected from the group consisting of Group III elements and Group V elements.

(15) The electroluminescent device as described in any one of (1) to (14), the phosphor particle is a semiconductor particle comprising at least one of CdS, CdSe, CdTe, ZnS, ZnSe, ZnTe, CaS, MgS, SrS, GaP and GaAs.

(16) A flat light source system comprising an electroluminescent device as described in any one of (1) to (15), wherein the electroluminescent device is driven by an AC electric field of 500 Hz to 5 kHz.

### DETAILED DESCRIPTION OF THE INVENTION

The present invention is described in detail below.

In the dispersion-type electroluminescent device of the present invention, the following constitutions can be preferably used.

Transparent Conductive Film

The surface resistivity of the transparent conductive film for use in the present invention is from 0.05 to 50 Ω/□, preferably from 0.1 to 30 Ω/□, more preferably from 0.1 Ω/□ to 10 Ω/□. In the present invention, the transparent conductive film functions as a transparent electrode.

In the EL device of the present invention, the transparent conductive film preferably comprises a transparent film and a transparent electrode material thereon.

Examples of the transparent film include a polyethylene terephthalate film, a polyethylene naphthalate film and polyethersulfone film.

An arbitrary transparent electrode material generally employed is used for the transparent electrode material. Examples thereof include an oxide such as Indium-doped tin oxide (ITO), antimony-doped tin oxide and zinc-doped tin oxide, a multilayer structure comprising high refractive index layers having interposed therebetween a silver thin film, and a conjugated polymer such as polyaniline and polypyrrole.

However, with such a transparent electrode material alone, a sufficiently low resistance may not be attained. In this case, the electric conduction is preferably improved by disposing a thin metallic wire of comb type, grid type or the like.

The material for the thin metallic wire is preferably gold, platinum, copper, silver, aluminum or an alloy thereof, more preferably silver, copper or an alloy thereof.

Of course, a transparent conductive membrane comprising only a thin wire formed on a transparent film is also preferred. The transparent conductive membrane may also be prepared by a vapor phase process such as sputtering and vacuum deposition.

Back Electrode

For the back electrode on the side of not needing to penetrate light, an arbitrary conductive material can be used. From metals such as gold, silver, platinum, copper, iron and aluminum, an appropriate material is selected by taking account of the shape of the device produced, the temperature in the production process, or the like. Among these, since a high thermal conductivity is important, metals having a thermal conductivity of 2.8 W/cm·deg or more are preferred, and metals having a thermal conductivity of 3.3 W/cm·deg or more are more preferred. Silver, copper and alloy thereof are most preferred.

Also, in order to ensure high heat radiation and high electric conduction, a metal sheet or a metal mesh may be preferably used in the periphery of the EL device.

Sealing

The EL device of the present invention is preferably processed at the end by using an appropriate sealing material so as to eliminate the effect of moisture from the external environment. In the case where the device substrate itself has a sufficiently high blocking property, the sealing is preferably performed by superposing a blocking sheet on the top or both surfaces of the device produced and sealing the circumference with a curable material such as epoxy.

The blocking sheet is selected from glass, metal, plastic film and the like according to the purpose, but a moisture-proof film having a multilayer structure consisting of a layer formed of silicon oxide and an organic polymer compound described, for example, in JP-A-2003-249349 can be preferably used.

The sealing step is, as described in JP-B-63-27837, preferably performed in a vacuum or in an atmosphere purged with an inert gas and it is important, as described in JP-A-5-166582, to satisfactorily reduce the water content before the sealing step.

Dielectric Layer

In the present invention, a dielectric layer is preferably provided. The dielectric material for use in the present invention may be a thin-film crystal layer or may have a particle shape. A combination thereof may also be used. The dielectric layer containing the dielectric material may be provided on one side of the light-emitting layer but is preferably provided on both sides of the light-emitting layer. In the case of a thin-film crystal layer, a thin film may be formed on the substrate by a vapor phase process such as sputtering. The film may also be a sol-gel film using an alkoxide such as Ba or Sr. In the case of a particle-shaped dielectric material, the size is preferably sufficiently small for the size of the phosphor particle. More specifically, the size is preferably from ⅓ to 1/1,000 the phosphor-particle size.

Furthermore, in the case where the EL device has a small thickness and is excited by a high electric field as in the present invention, it is important that the distance between electrodes sandwiching the EL device is uniform. More specifically, when the fluctuation of the distance between electrodes is viewed as the center line average roughness Ra, this is preferably Ra=d/8 or less based on the thickness d of the light-emitting layer.

Phosphor Particle

The electroluminescent phosphor particle for use in the present invention preferably has an average equivalent-sphere diameter of 0.15 to 15 μm, more preferably from 1 to 10 μm. The coefficient of variation in the equivalent-sphere diameter is preferably 30% or less, more preferably from 5 to 20%. As for the preparation method of the phosphor particle, a baking method, a urea fusion method, a spray-pyrolysis technique and a hydrothermal method can be preferably used.

The particle synthesized preferably has a multiple twin crystal structure. In the case of zinc sulfide, the distance between twin boundaries of the multiple twin crystal (stacking fault structure) is preferably from 1 to 10 nm, more preferably from 2 to 5 nm.

In the present invention, the percentage of stacking faults of the phosphor particle is assessed by grinding and cracking the particle in a mortar into fragments having a thickness of 0.2 μm or less and observing the fragments through an electron microscope at an accelerating voltage of 200 kV. Particles having a thickness of less than 0.2 μm need not be ground and are as-is observed.

In the electroluminescent device of the present invention, when the stacking fault is evaluated by the above-described method on fragments obtained by cracking the phosphor particle contained in the light-emitting layer into a thickness of 0.15 to 0.2 μm and on the phosphor particles having a thickness of 0.15 to 0.2 μm contained in the light-emitting layer, the percentage of the stacking fault structure having 10 or more stacking faults at intervals of 5 nm or less in the fragments and particles is preferably 50% (pieces) or more, more preferably 60% (pieces) or more, still more preferably 70% (pieces) of more. As this percentage is higher, more preferred. The layer-to-layer distance of the stacking faults is preferably narrower.

The fine phosphor particle which can be used in the present invention can be formed by a baking method (solid-phase process) widely used in this industry. For example, in the case of zinc sulfide, a fine particle powder (usually called raw powder) of 10 to 50 nm is prepared by a liquid-phase process and this powder which is used as the primary particle is mixed with impurities called an activator and subjected together with a fusing agent to a first baking in a mortar at a high temperature of 900 to 1,300° C. for 30 minutes to 10 hours to obtain the particle.

The intermediate phosphor powder obtained by the first baking is repeatedly washed with ion exchanged water to remove alkali metal, alkaline earth metal and excess activator and co-activator.

Subsequently, the resulting intermediate phosphor powder is subjected to a second baking. The second baking is performed by heating (annealing) at a temperature lower than the first baking, that is, from 500 to 800° C., for a time period shorter than the first baking, that is, from 30 minutes to 3 hours.

By these bakings, many stacking faults are generated in the phosphor particle. Appropriate conditions are preferably selected for the first baking and second baking so that the phosphor particle can be formed as a fine particle and contain a larger number of stacking faults.

When an impact in a certain strength range is imposed on the first baked product, the density of stacking faults can be greatly increased without destroying the particle. Preferred examples of the method for imposing an impact include a method of contact-mixing intermediate phosphor particles with each other, a method of blending alumina-balls or the like in the intermediate phosphor powder and mixing the powder (ball mill method), a method of accelerating and colliding the particles, and a method of irradiating an ultrasonic wave. By using such a method, a particle having stacking faults of 10 or more layers at intervals of 5 nm or less can be formed.

Thereafter, the intermediate phosphor is etched with an acid such as HCl to remove metal oxide adhering to the surface and further washed with KCN to remove copper sulfide adhering to the surface. This intermediate phosphor is then dried to obtain an EL phosphor.

In the case of zinc sulfide or the like, the phosphor particle is preferably formed by a hydrothermal method so as to introduce a multiple twin crystal structure into the phosphor crystal. In the hydrothermal synthesis method, the particles are dispersed in a well-stirred water solvent and at least one of zinc ion and sulfur ion for bringing about the growth of particle is added in the form of an aqueous solution from the outside of the reaction vessel at a controlled flow rate for a predetermined time. Accordingly, in this system, the particle can freely move in the water solvent and the ion added can diffuse in water to uniformly cause the growth of particle, so that the concentration distribution of activator or co-activator inside the particle can be varied and a particle unobtainable by a baking method can be obtained. As for the control of particle size distribution, the nucleation process can be distinctly separated from the growth process and at the same time, the supersaturation degree during the growth of particle can be freely controlled to control the particle size distribution, so that monodisperse zinc sulfide particles having a narrow size distribution can be obtained. For controlling the particle size and realizing a multiple twin crystal structure, an Ostwald ripening step is preferably provided between the nucleation process and the growth process.

For example, zinc sulfide crystal has very low solubility in water and this property is very disadvantageous for growing the particle by an ionic reaction in an aqueous solution. The solubility of ZnS crystal in water increases as the temperature is elevated, but water reaches the supercritical state at 375° C. or more and the solubility of ion sharply decreases. Accordingly, the temperature at the preparation of particle is preferably from 100 to 375° C., more preferably from 200 to 375° C. The time spent for the preparation of particle is preferably 100 hours or less, more preferably from 5 minutes to 12 hours.

As another method for increasing the solubility of zinc sulfide in water, a chelating agent is preferably used in the present invention. The chelating agent for Zn ion preferably has an amino group or a carboxyl group and specific examples thereof include ethylenediaminetetraacetic acid (hereinafter referred to as “EDTA”), N,2-hydroxyethyl ethylenediaminetriacetic acid (hereinafter referred to as “EDTA-OH”), diethylenetriaminepentaacetic acid, 2-aminoethylethylene glycol tetraacetic acid, 1,3-diamino-2-hydroxypropane tetraacetic acid, nitrilotriacetic acid, 2-hydroxyethyl iminodiacetic acid, iminodiacetic acid, 2-hydroxyethyl glycine, ammonia, methylamine, ethylamine, propylamine, diethylamine, diethylenetriamine, triaminotriethylamine, allylamine and ethanolamine.

In the case of preparing the phosphor particle by a direct precipitation reaction between constituent metal ion and chalcogen anion without using a constituent element precursor, the solutions of both ions must be rapidly mixed and therefore, a double jet-type mixer is preferably used.

A urea fusion method is also preferred as the phosphor-forming method usable in the present invention. The urea fusion method is a method of using fused urea as the medium for synthesizing a phosphor. In a solution where urea is fused by maintaining a temperature higher than the melting point, substances containing elements for constituting the phosphor matrix or activator are dissolved. If desired, a reactive agent is added. For example, in the case of synthesizing a sulfide phosphor, a sulfur source such as ammonium sulfate, thiourea or thioacetamide is added to cause a precipitation reaction. When the temperature of the resulting fused solution is gradually elevated to about 450° C., a solid where a phosphor particle and a phosphor intermediate are uniformly dispersed in a resin originated in the urea is obtained. This solid is finely ground and then baked while thermally decomposing the resin in an electric furnace. By selecting the baking atmosphere from inert atmosphere, oxidative atmosphere, reducing atmosphere, ammonia atmosphere and vacuum atmosphere, a phosphor particle comprising an oxide, sulfide or nitride as the matrix can be synthesized.

A spray-pyrolysis technique is also preferred as the phosphor-forming method usable in the present invention. A phosphor precursor solution is formed into a fine liquid droplet by using an atomizer and through condensation or chemical reaction within the liquid droplet or chemical reaction with an atmosphere gas in the periphery of liquid droplet, a phosphor particle or a phosphor intermediate product can be synthesized. By optimizing the conditions for the formation of liquid droplet, fine spherical particles homogenized in trace impurities and narrowed in the particle size distribution can be obtained. As for the atomizer for producing a fine liquid droplet, a two-fluid nozzle, an ultrasonic atomizer or an electrostatic atomizer is preferably used. The fine liquid droplet produced by the atomizer is introduced with a carrier gas into an electric furnace or the like, dehydrated condensed by heating and further through a chemical reaction or sintering of the substances in the liquid droplet with each other or a chemical reaction with an atmosphere gas, a phosphor particle or a phosphor intermediate product is obtained. The obtained particle is, if desired, additionally baked.

For example, in the case of synthesizing a zinc sulfide phosphor, a mixed solution of zinc nitrate and thiourea is atomized and thermally decomposed at about 800° C. in an inert gas (for example, nitrogen), whereby a spherical zinc sulfide phosphor is obtained. When trace impurities such as Mn, Cu and rare earth are dissolved in the starting mixed solution, these impurities act as an emission center. Also, when a mixed solution of yttrium nitrate and europium nitrate is used as a starting solution and thermally decomposed at about 1,000° C. in an oxygen atmosphere, an europium-activated yttrium oxide phosphor is obtained.

In the liquid droplet, the components need not be all dissolved and ultrafine particulate silicon dioxide may also be contained. When a fine liquid droplet containing zinc solution and ultrafine particulate silicon dioxide is thermally decomposed, a zinc silicate phosphor particle is obtained.

Other examples of the phosphor-forming method which can be in the present invention include a vapor phase method such as laser-ablation method, CVD method, plasma CVD method, sputtering and method combining resistance heating and electron beam process with fluidized oil surface deposition, and a liquid phase method such as double decomposition method, method utilizing a thermal decomposition reaction of precursor, reversed micelle method, such a method combined with high-temperature baking, and freeze drying method.

The phosphor particle is preferably imparted with waterproofness and water resistance by covering it, as described in Japanese Patent No. 2,756,044 and U.S. Pat. No. 6,458,512, with a non-emitting shell layer comprising a metal oxide or a metal nitride and having a thickness of 0.01 μm or more.

Also, a technique of forming a double structure consisting of a core part containing an emission center and a non-emitting shell part, thereby enhancing the light penetration efficiency described in WO 02/080626, pamphlet, can be preferably used.

The phosphor particle more preferably has a non-emitting shell layer on the particle surface. This shell layer is preferably formed to a thickness of 0.01 μm or more, more preferably from 0.01 to 1.0 μm, by a chemical method subsequently to the preparation of a fine semiconductor particle which works out to the core of the phosphor particle.

The non-emitting shell layer can be formed from an oxide, a nitride, an oxynitride, a substance having the same composition as the matrix phosphor particle on which the substance is formed and not containing an emission center, or a substance epitaxially grown on the matrix phosphor particle and differing in the composition.

The non-emitting shell layer can be formed, for example, by a vapor phase method such as laser•ablation method, CVD method, plasma CVD method, sputtering and method combining resistance heating and electron beam process with fluidized oil surface deposition, a liquid phase method such as double decomposition method, sol-gel method, ultrasonic chemical method, method utilizing a thermal decomposition reaction of precursor, reversed micelle method, method combining such as method with high-temperature baking, hydrothermal method, urea fusion method and freeze drying method, or a spray-pyrolysis technique.

In particular, a hydrothermal method, a urea fusion method and a spray-pyrolysis technique which are suitably used for the formation of phosphor particle is also suited for the synthesis of the non-emitting shell layer.

For example, in the case of providing a non-emitting shell layer on the surface of a zinc sulfide phosphor particle by using a hydrothermal method, a zinc sulfide phosphor working out to a core particle is added to a solvent and suspended. Similarly to the particle formation, a metal ion working out to the non-emitting shell layer material and, if desired, a solution containing anion are added from the outside of the reaction vessel each at a controlled flow rate for a predetermined time. When the inside of the reactor is well stirred, the particle can freely move in the solvent and at the same time, the ion added can diffuse in the solvent to uniformly cause the particle growth, so that a non-emitting shell layer can be uniformly formed on the core particle surface. The obtained particle is, if desired, baked, whereby a zinc sulfide phosphor particle having on the surface thereof a non-emitting shell layer can be synthesized.

In the case of providing a non-emitting shell layer on the surface of a zinc sulfide phosphor particle by using a urea fusion method, a zinc sulfide phosphor is added in a urea solution having dissolved and fused therein a metal salt working out to the non-emitting shell layer material. The zinc sulfide does not dissolve in urea and therefore, the temperature of the solution is elevated in the same manner as in the particle formation to obtain a solid where a zinc sulfide phosphor and a non-emitting shell layer material are uniformly dispersed in a resin originated urea. This solid is finely ground and then baked while thermally decomposing the resin in an electric furnace. By selecting the baking atmosphere from inert atmosphere, oxidative atmosphere, reducing atmosphere, ammonia atmosphere and vacuum atmosphere, a zinc sulfide phosphor particle having on the surface thereof a non-emitting shell layer comprising an oxide, a sulfide or a nitride can be synthesized.

In the case of providing a non-emitting shell layer on the surface of a zinc sulfide phosphor particle by using a spray-pyrolysis technique, a zinc sulfide phosphor is added in a solution having dissolved therein a metal salt working out to the non-emitting shell layer material. This solution is atomized and thermally decomposed, whereby a non-emitting shell layer is produced on the surface of a zinc sulfide phosphor particle. By selecting the thermal decomposition atmosphere or additional baking atmosphere, a zinc sulfide phosphor particle having on the surface thereof a non-emitting shell layer comprising an oxide, a sulfide or a nitride can be synthesized.

The activator of the phosphor particle is preferably at least one ion selected from copper, manganese, silver, gold and rare earth elements.

The co-activator is preferably at least one ion selected from chlorine, bromine, iodine and aluminum.

In the electroluminescent device of the present invention, the average thickness of the light-emitting layer is preferably from 1 to 25 μm, more preferably from 3 to 20 μm, still more preferably from 5 to 15 μm.

The device has a constitution where a light-emitting layer containing a phosphor particle is interposed between a pair of opposing electrodes with one electrode being transparent. The total thickness of the light-emitting layer containing a phosphor particle and an insulating layer containing an inorganic dielectric material which is provided to adjoin, if desired, is preferably from 2 to 10 times, more preferably from 2 to 5 times, the average equivalent-sphere diameter of the phosphor.

The phosphor particle for use in the present invention is described in more detail below.

The matrix material of the particle preferably used in the present invention is a fine semiconductor particle comprising one or multiple element(s) selected from the group consisting of Group II elements and Group VI elements and one or multiple element(s) selected from the group consisting of Group III elements and Group V elements, and a semiconductor having a necessary emission wavelength region is arbitrarily selected. Examples thereof include CdS, CdSe, CdTe, ZnS, ZnSe, ZnTe, CaS, MgS, SrS, GaP, GaAs and a mixed crystal thereof. Among these, ZnS, CdS and CaS are preferred.

Other preferred examples of the matrix material of the particle include BaAl₂S₄, GaGa₂S₄, Ga₂O₃, Zn₂SiO₄, Zn₂GaO₄, ZnGa₂O₄, ZnGeO₃, ZnGeO₄, ZnAl₂O₄, CaGa₂O₄, CaGeO₃, Ca₂Ge₂O₇, CaO, Ga₂O₃, GeO₂, SrAl₂O₄, SrGa₂O₄, SrP₂O₇, MgGa₂O₄, Mg₂GeO₄, MgGeO₃, BaAl₂O₄, Ga₂Ge₂O₇, BeGa₂O₄, Y₂SiO₅, Y₂GeO₅, Y₂Ge₂O₇, Y₄GeO₈, Y₂O₃, Y₂O₂S, SnO₂ and a mixed crystal thereof.

The emission center is preferably a metal ion such as Mn and Cr, or a rare earth.

By selecting the matrix material and using several phosphors, white light emission in the range of 0.3<x<0.4 and 0.3<y<0.4 on the chromaticity can be obtained without using substantially no dye or fluorescent dye.

Binder

The El device of the present invention basically has a constitution that a light-emitting layer is interposed between a pair of opposing electrodes with at least one electrode being transparent. A dielectric layer is preferably provided to adjoin between the light-emitting layer and the electrode.

The light-emitting layer is formed of a material obtained by dispersing phosphor particles in a binder. Examples of the binder which can be used include polymers having a relatively high dielectric constant, such as cyanoethyl cellulose resin, and resins such as polyethylene, polypropylene, polystyrene resin, silicon resin, epoxy resin and vinylidene fluoride. In this resin, a fine particle having a high dielectric constant, such as BaTiO₃ and SrTiO₃, can be appropriately mixed to adjust the dielectric constant. The particles can be dispersed by using a homogenizer, a planetary kneader, a roll kneader, an ultrasonic disperser or the like. The amount of the phosphor particle for use in the present invention is, in terms of the weight ratio, preferably from 4.2 to 20, more preferably from 4.5 to 10, based on the amount of the binder.

For the dielectric layer, an arbitrary material can be used as long as it has high dielectric constant, high insulating property and high dielectric breakdown voltage. This material is selected from metal oxides and nitrides and examples thereof include TiO₂, BaTiO₃, SrTiO₃, PbTiO₃, KNbO₃, PbNbO₃, Ta₂O₃, BaTa₂O₆, LiTaO₃, Y₂O₃, Al₂O₃, ZrO₂, AlON and ZnS. The dielectric layer may be disposed as a uniform film or a film having a particle structure.

The light-emitting layer and the dielectric layer each is preferably coated by using a spin coating method, a dip coating method, a bar coating method, a spray coating method or the like. In particular, a method applicable to any printing surface, such as screen printing method, or a method capable of continuous coating, such as slide coating method, is preferred. For example, in the screen printing method, a dispersion obtained by dispersing fine phosphor or dielectric particles in a polymer solution having a high dielectric constant is coated through a screen mesh. By selecting the thickness of mesh, the opening ratio or the number of coatings, the layer thickness can be controlled. By changing the dispersion, not only the phosphor or dielectric layer but also the back electrode layer can be formed. Furthermore, large-area formation can be easily obtained by changing the size of the screen.

Light-Emitting Layer

In the EL device of the present invention, the thickness of the light-emitting layer is preferably small. Particularly, the average thickness is from 1 to 25 μm. The lower limit of the thickness of the light-emitting layer is the phosphor particle size but for ensuring smoothness of the device, the thickness of the light-emitting layer is preferably from 1.1 to 10 times the phosphor particle size.

The phosphor particle contained in the light-emitting layer is preferably contacting with the dielectric substance. The phosphor particle and the dielectric substance are preferably contacting in the state that the phosphor particle is completely or partially covered with a non-emitting shell. It is also possible that the phosphor particle and the dielectric substance are merely contacting.

When the dielectric layer is coated to cover a part of the upper part of the particle, that is, to partially enter into a part of the light-emitting layer, this is preferred because an effect of increasing the contact point or improving the smoothness on the device surface can be obtained.

White

The use of the present invention is not particularly limited but in view of use as a light source, the emission color is preferably white.

The white color emission is preferably formed, for example, by a method of using a phosphor particle capable of emitting white light by itself, such as zinc sulfide phosphor activated with copper and manganese and gradually cooled after baking, or a method of mixing multiple phosphors capable of emitting light of three primary colors or complementary colors (for example, a combination of blue-green-red or bluish green-orange). In addition, as described in JP-A-7-166161, JP-A-9-245511 and JP-A-2002-62530, a method of emitting light at a short wavelength, such as blue, and causing a part of the emission to undergo wavelength conversion (emission) into green or red by using a fluorescent pigment or dye is also preferred. The CIE chromaticity coordinate (x, y) is preferably such that the x value is from 0.30 to 0.4 and the y value is from 0.30 to 0.40.

The electroluminescent device of the present invention comprises a transparent conductive film, a light-emitting layer containing a phosphor particle and a binder, and a back electrode layer. Other than these, in the device of the present invention, a substrate, a transparent electrode, a dielectric layer, various protective layers, a filter, a light scattering/reflecting layer or the like can be provided, if desired. Particularly, as for the substrate, a flexible transparent resin sheet can be preferably used, in addition to a glass substrate and a ceramic substrate.

In the present invention, a phosphor particle having the above-described characteristics and an EL device constitution are preferably combined appropriately, whereby a high-luminance and high-efficiency EL device can be provided.

According to the preferred embodiment described above, the electroluminescent device of the present invention can emit light of 300 cd/m² or more. Even when such high luminance is obtained, the power consumption is as small as 100 W/m² or less. In this way, low power consumption is realized and heat generation is thereby reduced, as a result, the device itself is enhanced in the durability and prolonged in the life. Furthermore, sufficiently high luminance can be provided for a transmitted print image having a high image quality with a maximum density of 1.5 or more, and a large-area advertisement or the like having a high image quality can be realized.

Voltage and Frequency

The dispersion-type electroluminescent device is usually driven by AC, typically by using an AC power source of 100 V at 50 to 400 Hz. When the area is small, the luminance increases almost in proportion to the applied voltage and frequency. However, in the case of a large-area device of 0.25 m² or more, the capacitance component of the device increases and the impedance matching between the device and the power source may be slipped or the time constant necessary for accumulating electric charge in the device increases, as a result, even when a high voltage particularly at a high frequency is applied, failure in sufficiently supplying electric power is liable to occur. In particular, when a device of 0.25 m² or more is driven by AC at 500 Hz or more, the applied voltage often decreases for the increase of the driving frequency and low luminance frequently results.

On the other hand, the electroluminescent device of the present invention can be driven at a high frequency even when the size is as large as 0.25 m² or more, and can realize high luminance. The electroluminescent device of the present invention preferably has an emission area of 0.25 to 100 m². The driving frequency is preferably from 500 Hz to 5 kHz, more preferably from 800 Hz to 4 kHz.

### EXAMPLES

### Example 1

Phosphor Particle A

In an alumina-made crucible, a dry powder containing 25 g of a zinc sulfide (ZnS) particle powder having an average particle size of 20 nm, in which copper sulfate was added in an amount of 0.07 mol % based on ZnS, was charged together with NaCl and MgCl as fusing agents as well as an appropriate amount of an ammonium chloride (NH₃Cl) powder and a magnesium oxide powder in an amount of 20 wt % based on the phosphor powder. These were baked at 1,200° C. for 3 hours. The resulting powder was rapidly cooled, taken out and dispersed by grinding in a ball mill. Thereto, 5 g of ZnCl₂ and copper sulfate in an amount of 0.10 mol % based on ZnS were added and 1 g of MgCl₂ was further added to prepare a dry powder. The powder obtained was again charged into the alumina crucible and baked at 700° C. for 6 hours. At this time, the baking was performed in an atmosphere under flow of 10% hydrogen sulfide.

The baked particle was again ground, dispersed and precipitated in H₂O at 40° C. and after removing the supernatant, washed. Thereto, a 10% hydrochloric acid solution was added to disperse-precipitate the particle and the supernatant was removed. After removing unnecessary salts, the particle was dried, and Cu ion and the like on the surface was removed with a 10% KCN solution heated at 70° C.

Subsequently, the surface layer corresponding to 10 wt % of the entire particle was etched with 6N hydrochloric acid.

The thus-obtained phosphor particle had an average particle size (average equivalent-sphere diameter) of 9.6 μm and a coefficient of variation of 20%, and exhibited blue-green light emission having a luminescence peak of 490 nm. When fragments obtained by cracking the particle into a thickness of 0.15 to 0.20 μm were observed through an electron microscope, at least 80% or more of fragments had 10 layers or more of stacking faults at intervals of 5 nm or less.

Phosphor Particle B

Baking was performed at 1,250° C. for 2.5 hours under the same conditions as in the preparation of Phosphor Particle A except for preparing and using a dry powder containing 25 g of a zinc sulfide (ZnS) particle powder having an average particle size of 20 nm, in which copper sulfate and manganese carbonate were added in an amount of 0.06 mol % and 0.3 mol %, respectively, based on ZnS. The subsequent steps were performed in the same manner as in the production process of Phosphor Particle A, whereby Phosphor Particle B was produced.

The thus-obtained Phosphor Particle B had an average particle size (average equivalent-sphere diameter) of 9.0 μm and exhibited orange light emission. When this particle was cracked into a thickness of 0.15 to 0.20 μm, at least 85% or more of fragments had stacking faults of 10 or more layers at intervals of 5 nm or less.

By using Phosphor Particles A and B obtained above, a white EL device was produced by the following method.

Fine BaTiO₂ particles having an average particle size of 0.02 μm were dispersed in a 30 wt % cyanoresin solution and the obtained solution was coated on a 75 μm-thick aluminum sheet to form a dielectric layer having a thickness of 25 μm and then dried at 120° C. for 1 hour by using a hot air dryer.

Phosphor Particles A and B were mixed to give a ratio of x=3.3±0.2 and y=3.4±0.2 on the CIE chromaticity coordinate and dispersed in a cyanoresin solution having a concentration of 30 wt %. At this time, the weight ratio of phosphor particle and cyanoresin was 5:1. The obtained dispersion was coated on an ITO-coated transparent film substrate of 0.5 m×0.7 m to form a light-emitting layer having a thickness of 20 μm on the dielectric layer and then dried at 120° C. for 1 hour by using a hot air dryer.

A terminal for external connection was taken out from each of the transparent electrode and the back electrode of the device by using a copper aluminum sheet having a thickness of 80 μm and the device was interposed between two moisture-proof sheets having an SiO₂ layer of two water-absorbing sheets comprising nylon 6, and press-bonded under heat.

The thus-fabricated light emitting device of the present invention was designated as Sample 1. Based on Sample 1, devices were fabricated by changing the resistivity of the transparent conductive film, the thickness of the light-emitting layer, the material of the back electrode, and the area of the device. These devices each was driven and the luminance at that time was evaluated. In the column of luminance of Table 1, the upper case shows the luminance when the device was driven at 100 V and 1 kHz, and the lower case shows the luminance when driven at 150 V and 2 kHz. Each value of luminance is a relative luminance assuming that the luminance obtained by driving Sample 2 at 1 kHz was 100.

TABLE 1

| | Transparent | | Kind of Back | | | |
|---|---|---|---|---|---|---|
| | conductive film, | Thickness of Light- | Electrode, Heat | | | |
| Sample | Resistance | emitting layer | Conductivity thereof | Relative | | |
| No. | thereof (Ω/□) | (μm) | (W/cm · deg) | Luminance | Others | Remarks |
| 1 | ITO | 15.0 | aluminum | 130 | small generation of heat | Invention |
| | 30 | | 2.35 | 380 | | |
| 2 | ITO | 15.0 | aluminum | 100 | large generation of heat | Comparison |
| | 150 | | 2.35 | 250 | | |
| 3 | ITO + Cu thin wire | 15.0 | aluminum | 230 | small generation of heat | Invention |
| | 0.1 | | 2.35 | 630 | | |
| 4 | ITO + Cu thin wire | 15.0 | aluminum | 0 | wire was broken when bent | Comparison |
| | 0.005 | | 2.35 | 0 | | |
| 5 | ITO + Cu thin wire | 30.0 | aluminum | 90 | large generation of heat | Comparison |
| | 0.1 | | 2.35 | 220 | | |
| 6 | ITO + Cu thin wire | 20.0 | aluminum | 110 | small generation of heat | Invention |
| | 0.1 | | 2.35 | 330 | | |
| 7 | ITO + Cu thin wire | 10.0 | aluminum | 280 | small generation of heat | Invention |
| | 0.1 | | 2.35 | 800 | | |
| 8 | ITO + Cu thin wire | 10.0 | copper | 320 | no generation of heat | Invention |
| | 0.1 | | 4.01 | 910 | | |
| 9 | ITO + Cu thin wire | 10.0 | Ag | 330 | no generation of heat | Invention |
| | 0.1 | | 4.28 | 950 | | |
| 10 | ITO + Cu thin wire | 10.0 | carbon paste* | 80 | large generation of heat | Comparison |
| | 0.1 | | 2.0 or less | 200 | | |
| 11 | ITO + Cu thin wire | 10.0 | copper paste* | 220 | small generation of heat | Invention |
| | 0.1 | | 2.0 or less | 530 | | |

*In the case of using a paste for the back electrode, the device was fabricated by sequentially coating the layers from the transparent electrode side.

The device of Example 1 was (i) worked into a size of 0.1 m×0.3 m and the relationship between the luminance and driving frequency was compared with that of (ii) a sample worked into a size of 0.5 m×0.7 m. The results are shown in Table 2. The upper case is the result of (i) a small-area device and the lower case is the result of the device of (ii). Each shows a relative luminance assuming that the luminance obtained by driving Sample 2 in a size of 0.5 m×0.7 m at 1 kHz was 100.

Table 2: Relationship of Luminance with Driving Frequency and Emission Area

| | Sample 2, | Sample 5, | | |
|---|---|---|---|---|
| | Comparative | Comparative | Sample 7, | Sample 8, |
| | Example | Example | Invention | Invention |
| 50 Hz | 18 | 5 | 18 | 19 |
| | 18 | 5 | 18 | 19 |
| 200 Hz | 70 | 20 | 60 | 65 |
| | 60 | 20 | 59 | 64 |
| 400 Hz | 130 | 38 | 110 | 130 |
| | 100 | 35 | 107 | 123 |
| 600 Hz | 150 | 57 | 160 | 200 |
| | 120 | 53 | 155 | 190 |
| 1 kHz | 140 | 93 | 300 | 320 |
| | 100 | 90 | 280 | 300 |
| 2 kHz | 120 | 175 | 550 | 600 |
| | 90 | 140 | 510 | 550 |
| 4 kHz | 110 | 340 | 900 | 1100 |
| | 80 | 200 | 830 | 1000 |
| 6 kHz | 90 | 330 | 1000 | 1350 |
| | shortcircuited | 230 | 900 | 1250 |

Shown by relative luminance assuming that the luminance obtained by driving Sample 2 at 100 V and 1 kHz was 100.

It is seen that in the electroluminescent device of the present invention, as the area is larger and as the driving frequency is higher and 500 Hz or more, higher luminance can be relatively realized.

### Example 2

EL device Samples 12 to 17 were fabricated in the same manner as Sample 1 of Example 1 except for changing the amount of MgO at the baking of Phosphor Particle A in Example 1 and fabricating the device by a 100% Phosphor Particle A-type method. In this Example, phosphor particles differing in the phosphor particle size (average equivalent-sphere diameter) were produced. The relative luminance was determined by driving the device under the conditions of 100 V and 1 kHz similarly to Example 1 and the results obtained are shown in Table 3. It is seen that the particle size of the present invention is important for realizing high luminance.

TABLE 3
Effect of Phosphor Particle Size

| | Average Equivalent-Sphere | |
|---|---|---|
| Sample No. | Diameter (μm) | Relative Luminance |
| 12 | 9.0 | 100 |
| 13 | 21.0 | 35 |
| 14 | 13.0 | 90 |
| 15 | 2.2 | 110 |
| 16 | 1.3 | 80 |
| 17 | 0.5 | 10 |

### Example 3

EL device Samples 18 to 22 were fabricated in the same manner as Sample 12 of Example 2 except that the ball milling conditions and second sintering temperature at the formation of phosphor particle were changed to produce particles differing in the distance and frequency of stacking faults. The luminance of each device was evaluated and the results obtained are shown in Table 4. The percentage of stacking faults was evaluated by the parcentage of fragment particles containing stacking faults of 10 or more layers at intervals of 5 nm or less when the particle was ground in a mortar and cracked into fragments having a thickness of 0.15 to 0.2 μm and the fragments were observed through an electron microscope at an accelerating voltage of 200 kV.

TABLE 4
Effect of Stacking fault Density

| | Frequency of Stacking fault | |
|---|---|---|
| Sample | Particles | Relative Luminance |
| 12 | 85% | 100 |
| 18 | 20% | 5 |
| 19 | 37% | 10 |
| 20 | 63% | 85 |
| 21 | 91% | 130 |
| 22 | 98% | 200 |

### Example 4

EL device Samples 23 to 26 were fabricated in the same manner as Sample 8 of Example 1 except for changing the weight ratio between the phosphor particle and the binder in the light-emitting layer as shown in Table 5. The evaluation was performed thoroughly in the same manner as in Example 1, as a result, it was confirmed that an EL device where the weight ratio of phosphor particle to binder is from 4.2 to 20 exhibits high performance.

TABLE 5
Effect of Phosphor Particle/Binder Ratio

| Sample | Weight Ratio of Phosphor | |
|---|---|---|
| No. | Particle/Binder | Relative Luminance |
| 23 | 4.0 | 190 |
| | | 460 |
| 8 | 5.0 | 320 |
| | | 910 |
| 24 | 7.0 | 330 |
| | | 960 |
| 25 | 10.0 | 300 |
| | | 860 |
| 26 | 25.0 | 0 (shortcircuited) |
| | | 0 (shortcircuited) |

The present application claims foreign priority based on Japanese Patent Application No. JP2003-389546, filed Nov. 19, 2003, the contents of which is incorporated herein by reference.

1. An electroluminescent device comprising:
a transparent conductive film;
a light-emitting layer comprising a phosphor particle and a binder; and
a back electrode,
wherein
the transparent conductive film has a surface resistivity of 0.05 to 50 Ω/□,
the light-emitting layer has an average thickness of 1 to 25 μm, and
the back electrode comprises a metal.

2. The electroluminescent device as claimed in claim 1, wherein the transparent conductive film has a surface resistivity of 0.1 to 30 Ω/□.

3. The electroluminescent device as claimed in claim 1, wherein the light-emitting layer has an average thickness of 3 to 20 μm.

4. The electroluminescent device as claimed in claim 1, wherein the metal comprises at least one of gold, silver, platinum, copper, iron and aluminum.

5. The electroluminescent device as claimed in claim 1, wherein the back electrode has a thermal conductivity of 2.8 W/cm·deg or more.

6. The electroluminescent device as claimed in claim 1, wherein the phosphor particle has an average equivalent-sphere diameter of 0.15 to 15 μm.

7. The electroluminescent device as claimed in claim 1, wherein the phosphor particle has an average equivalent-sphere diameter of 1 to 10 μm.

8. The electroluminescent device as claimed in claim 1, wherein the phosophor layer has a weight ratio of the phosphor particle to the binder of 4.2 to 20.

9. The electroluminescent device as claimed in claim 1, wherein the light-emitting layer has a weight ratio of the phosphor particle to the binder of 4.5 to 10.

10. The electroluminescent device as claimed in claim 1, wherein 50% or more of fragments having a thickness 0.15 to 0.2 μm, the fragments being obtained by crushing the phosphor particle having a thickness of more than 0.2 μm, and phosphor particles having a thickness of 0.15 to 0.2 μm are phosphor particles having stacking faults of 10 or more layers at intervals of 5 nm or less.

11. The electroluminescent device as claimed in claim 1, wherein 60% or more of fragments having a thickness 0.15 to 0.2 μm, the fragments being obtained by crushing the phosphor particle having a thickness of more than 0.2 μm, and phosphor particles having a thickness of 0.15 to 0.2 μm are phosphor particles having stacking faults of 10 or more layers at intervals of 5 nm or less.

12. The electroluminescent device as claimed in claim 1, wherein 70% or more of: fragments having a thickness 0.15 to 0.2 μm, the fragments being obtained by crushing the phosphor particle having a thickness of more than 0.2 μm, and phosphor particles having a thickness of 0.15 to 0.2 μm are phosphor particles having stacking faults of 10 or more layers at intervals of 5 nm or less.

13. The electroluminescent device as claimed in claim 1, which has an emission area of 0.25 m² or more.

14. The electroluminescent device as claimed in claim 1, wherein the phosphor particle is a semiconductor particle comprising:
at least one element selected from the group consisting of Group II elements and Group VI elements; and
at least one element selected from the group consisting of Group III elements and Group V elements.

15. The electroluminescent device as claimed in claim 1, the phosphor particle is a semiconductor particle comprising at least one of CdS, CdSe, CdTe, ZnS, ZnSe, ZnTe, CaS, MgS, SrS, GaP and GaAs.

16. A flat light source system comprising an electroluminescent device as claimed in claim 1, wherein the electroluminescent device is driven by an AC electric field of 500 Hz to 5 kHz.
